(19) United States
(12) Patent Application Publication
(10) Pub. No.: US 2026/0368681 A1
(43) Pub. Date: Nov. 19, 2026

(54) SYSTEMS AND METHODS OF AUTOMATED AGENT EVALUATION

(71) Applicant: GENESYS CLOUD SERVICES, INC., MENLO PARK, CA (US)

(72) Inventors: CHAKRIT NIMMANANT, NORTH YORK (CA); ANMOL JAWA, NORTH YORK (CA); ANTHONY C. LAM, NORTH YORK (CA); MATTHEW FUHRMANN, CARMEL, IN (US)

(73) Assignee: GENESYS CLOUD SERVICES, INC., MENLO PARK, CA (US)

(21) Appl. No.: 19/206,872

(22) Filed: May 13, 2025

(51) Int. Cl. G06Q 10/0639; G06Q 30/015

(52) U.S. Cl. CPC G06Q 10/06398; G06Q 30/015

(57) ABSTRACT

Systems and methods for automated agent evaluation are provided. In particular, a computing system may receive an evaluation request for evaluating a performance of an agent, obtain conversation data between the agent and a customer, obtain an evaluation question from an evaluation form applicable to the agent, automatically generate a suggested answer to the evaluation question using an automated evaluator, and display the suggested answer on the evaluation form on a graphical user interface.

### BACKGROUND

Call centers and other contact centers are used by many organizations to provide technical and other support to their end users. The end user may interact with human agents of the contact center by establishing electronic communications via one or more communication technologies including, for example, telephone, email, web chat, Short Message Service (SMS), dedicated software application(s), and/or other technologies.

Monitoring the quality of contact center agents'performance during customer interactions is essential for ensuring service efficiency, regulatory compliance, and customer satisfaction. Traditionally, performance assessments require human evaluators to review and analyze each interaction (e.g., audio recordings or transcripts) between a contact center agent and a customer, and to manually answer evaluation questions on an evaluation form for the corresponding agent. However, this manual evaluation process is labor-intensive, time-consuming, and inefficient, limiting the human evaluators'ability to conduct assessments effectively.

It is with respect to these and other general considerations that embodiments have been described. Also, although relatively specific problems have been discussed, it should be understood that the embodiments should not be limited to solving the specific problems identified in the background.

### SUMMARY

In accordance with an embodiment of the present disclosure, an automated agent evaluation is performed to evaluate the performance of a contact center agent using an automated evaluator. The automated evaluator is an artificial intelligence (AI) system that utilizes one or more machine learning models, such as a large language model (LLM). Each contact center agent is evaluated using an evaluation form that includes one or more evaluation questions designed to assess performance. The performance of the automated evaluator in generating suggested answers for a given evaluation question may vary based on several factors, including the clarity or context of the evaluation question itself, the quality of the conversation data, and/or the language proficiency of the automated evaluator. In other words, the competency of the automated evaluator may differ depending on the specific evaluation question. Accordingly, the performance of automated evaluator is continuously or periodically assessed for each evaluation question on the evaluation form to ensure its competency.

In accordance with at least one example of the present disclosure, a method of automated agent evaluation is provided. The method may include receiving an evaluation request for evaluating a performance of an agent, obtaining conversation data between the agent and a customer, obtaining an evaluation question from an evaluation form applicable to the agent, automatically generating a suggested answer to the evaluation question using an automated evaluator, and displaying the suggested answer on the evaluation form on a graphical user interface.

In accordance with at least one example of the present disclosure, a computing system for automated agent evaluation is provided. The computing system may include at least one processor and at least one memory comprising a plurality of instructions stored therein that, in response to execution by the at least one processor, causes the computing system to receive an evaluation request for evaluating a performance of an agent, obtain conversation data between the agent and a customer, obtain an evaluation question from an evaluation form applicable to the agent, automatically generate a suggested answer to the evaluation question using an automated evaluator, and display the suggested answer on the evaluation form on a graphical user interface.

Any of the one or more above aspects in combination with any other of the one or more aspects. Any of the one or more aspects as described herein.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIGS. 3A and 3B are exemplary user interfaces of a computing device illustrating an exemplary evaluation form for evaluating a contact center agent in accordance with an embodiment of the present disclosure;

FIG. 4 is an exemplary user interface of a computing device illustrating an evaluation form editor in accordance with an embodiment of the present disclosure;

FIGS. 5A and 5B are an exemplary method of evaluating a performance of a contact center agent using an automated evaluator in accordance with an embodiment of the present disclosure; and

FIGS. 6A and 6B are an exemplary method of assessing a performance of the automated evaluator in accordance with an embodiment of the present disclosure.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

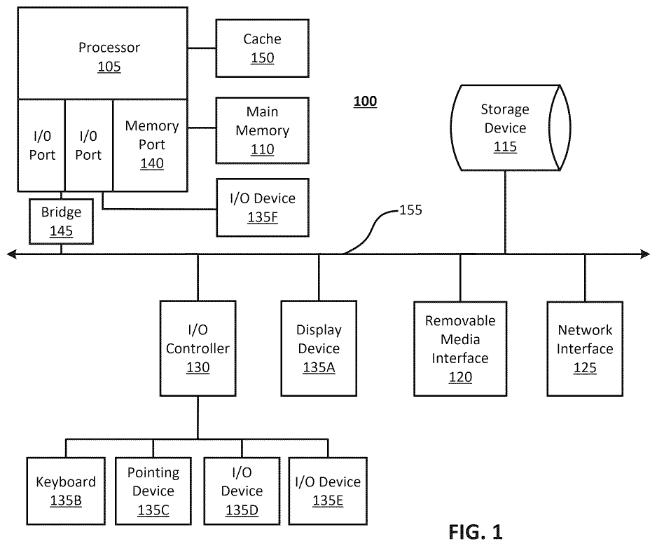

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

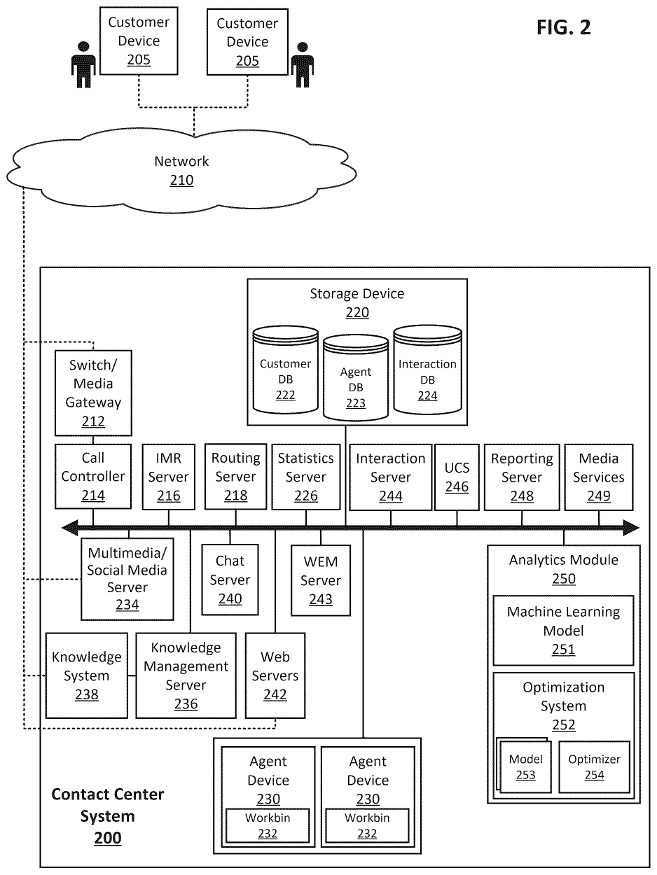

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing” or, simply, the “cloud” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Automated Evaluator

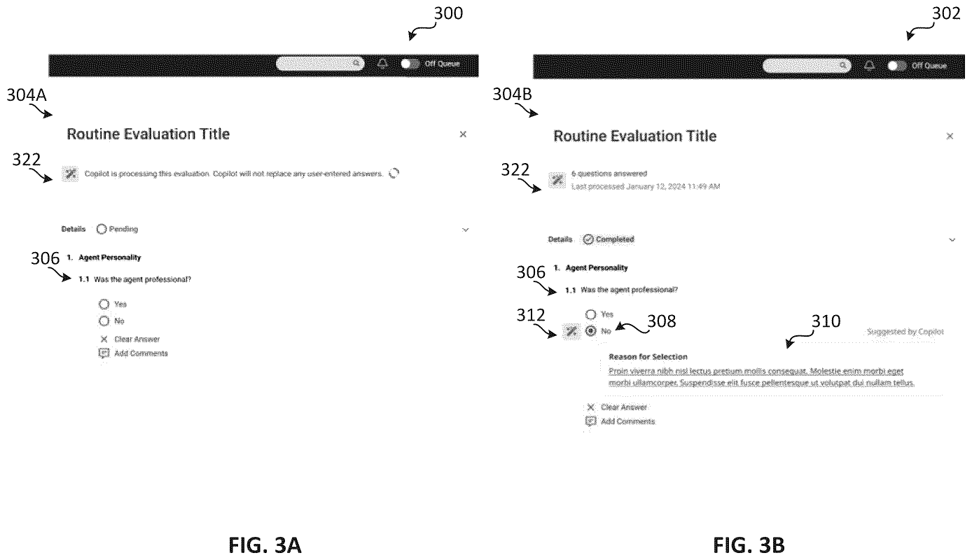

Turning now to FIGS. 3-6, the functionality of methods and systems related to an automated evaluator will be described.

Referring to FIGS. 3A and 3B, exemplary screenshots 300, 302 of an evaluation form for evaluating a contact center agent are shown. A computing system (e.g., the computing device 100, the contact center system 200, and/or other computing devices described herein) performs an evaluation of a contact center agent based on conversation data (e.g., conversation transcripts of conversations) between the contact center agent and a customer using an automated evaluator. The automated evaluator is an artificial intelligence (AI) system that utilizes one or more machine learning models, such as a large language model (LLM). The conversation data is structured as turn-by-turn utterances (e.g., voice or text) between contact center agents and customers via call, chat, message, and/or email. Exemplary conversation data includes transcripts, chat logs, message logs, and/or email threads of conversations between contact center agents and customers.

In the exemplary evaluation form 304A, an evaluation question 306 (i.e., question 1.1) has two evaluation answer options (i.e., “Yes” and “No”). As shown in the screenshot 300 of FIG. 3A, the evaluation form 304A displays the progress of the automated evaluation of the corresponding contact center agent in a designated progress section 322. As shown in the designated progress section 322, the automated evaluator (also refer to as “Copilot”) is processing the evaluation based on the conversation data. It should be appreciated that the automated evaluator will not replace or override any evaluation answers provided by one or more human evaluator.

Once the automated evaluator completes the evaluation, the evaluation form 304B is updated to show one or more suggested answers generated by the automated evaluator, as shown in the screenshot 302 of FIG. 3B. As shown in the designated progress section 322, the evaluation form 304B now has six questions answered by the automated evaluator (also refer to as “Copilot”). For the evaluation question 1.1, the suggested answer 308 (i.e., the evaluation answer option “No”) is selected by the automated evaluator and the reasoning for the suggested answer is displayed in the reasoning field 310. Additionally, an automated indicator 312 is displayed next to the corresponding suggested answer 308 to indicate that the suggested answer and the reasoning displayed in the corresponding reasoning field 310 were generated by the automated evaluator. It should be appreciated that, if the evaluation answer option “Yes” were to be previously selected by a human evaluator prior to the evaluation by the automated evaluator, the answer option “Yes” will still be selected and the automated indicator 312 will appear next to the answer option “No”. However, the answer option “No” will not be selected. In other words, the automated evaluator does not override the existing human evaluator answer but still provides the automated indicator 312 next to the suggested answer. Additionally, the evaluation form 304 further provides an option for a human evaluator to clear the selected answer, whether the answer is selected by the human evaluator or is selected by the automated evaluator with the automated indicator 312. For example, the human evaluator may review the suggested answer and the reasoning for the suggested answer and decide whether to accept the suggested answer.

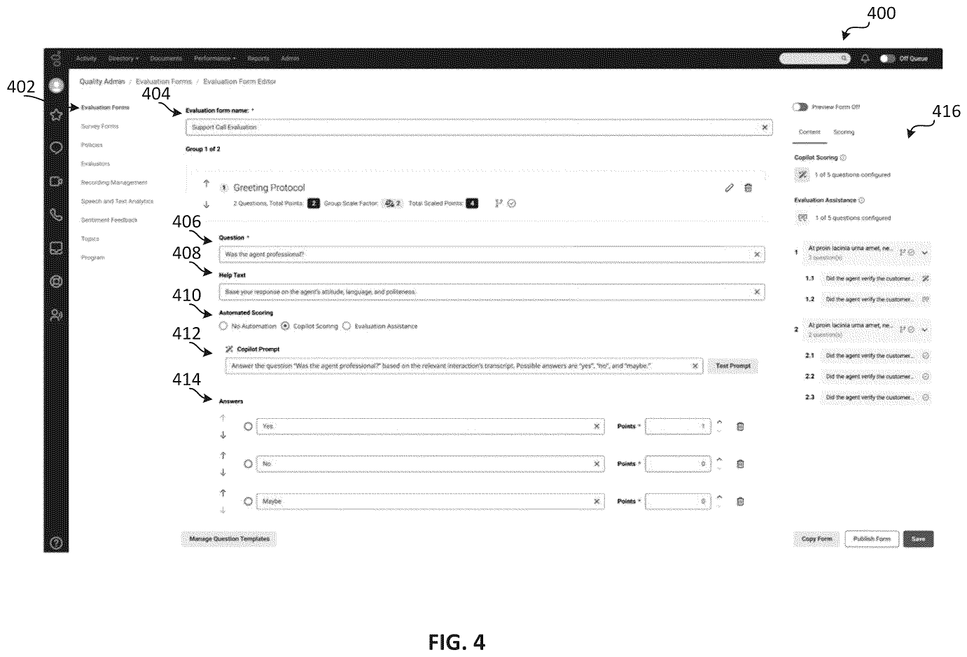

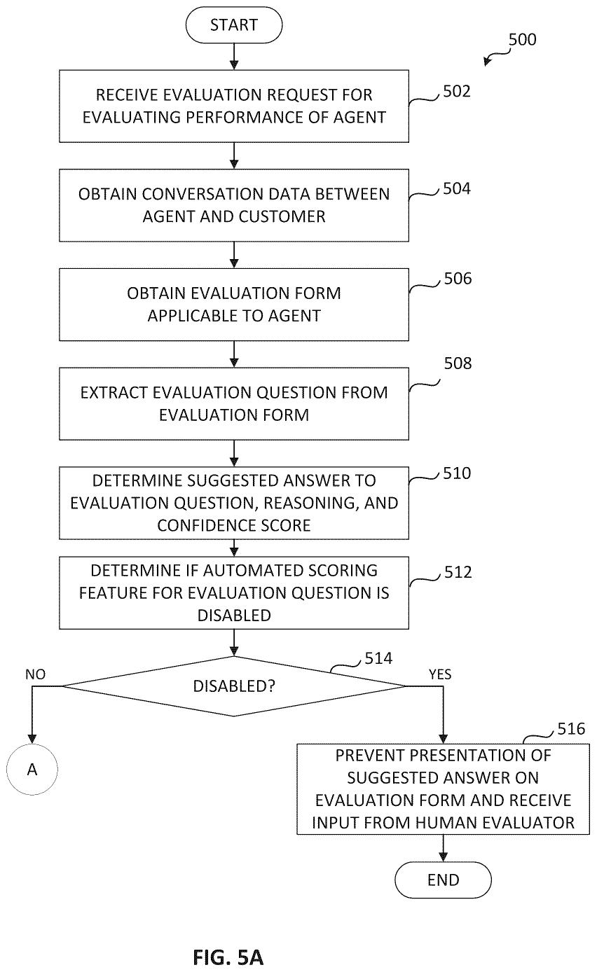

Referring now to FIG. 4, an exemplary screenshot 400 of an evaluation form editor is shown. A user (e.g., a human evaluator) of a computing system (e.g., the computing device 100, the contact center system 200, and/or other computing devices described herein) may create or edit evaluation forms to be used for evaluating contact center agents. Under the “Evaluation Forms” tab 402, the user may define an evaluation form name 404, one or more questions 406, any help text 408 (e.g., question clarifier text associated with the corresponding evaluation question), use of an automated scoring 410 (e.g., automated scoring feature), and one or more answer 414 for each evaluation question. If the automated scoring feature is enabled, the user may further input a prompt 412 to be used with the automated evaluator. Additionally, the content of the evaluation form is shown in a side panel 416. Subsequently, the user may “Copy Form” into a new evaluation form, “Publish Form” to be used for evaluating contact center agents, and/or “Save” the evaluation form for later.

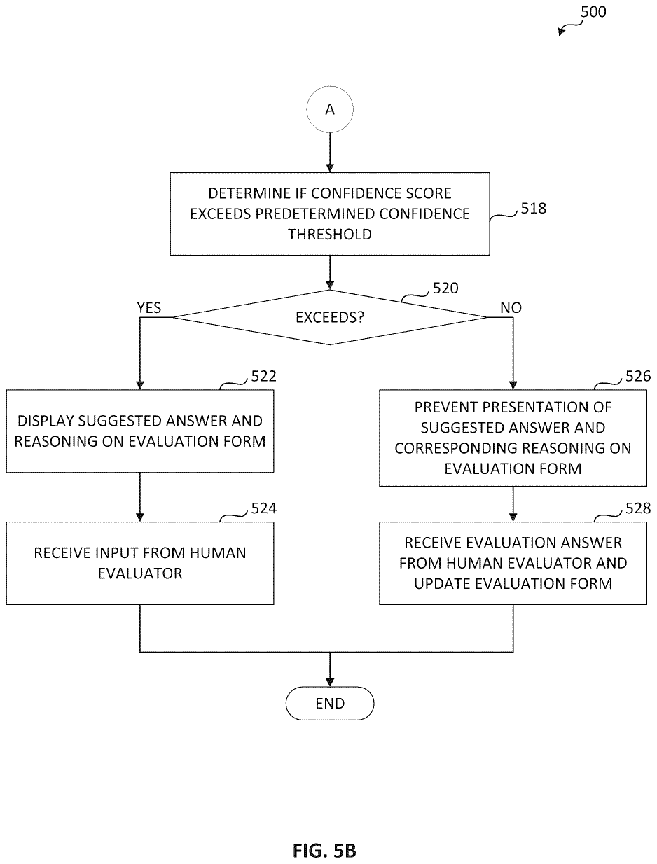

Referring now to FIGS. 5A and 5B, an exemplary automated evaluation process or method 500 is shown in accordance with aspects of the present disclosure. More specifically, in use, a computing system (e.g., the computing device 100, the contact center system 200, and/or other computing devices described herein) may execute a method 500 for automatically evaluating contact center agents from conversation data using an automated evaluator, which is an artificial intelligence (AI) system that utilizes one or more machine learning models, such as a large language model (LLM). It should be appreciated that the particular blocks of the method 500 are illustrated by way of example, and such blocks may be combined or divided, added or removed, and/or reordered in whole or in part depending on the particular embodiment, unless stated to the contrary.

The method 500 begins with block 502 in which the computing system receives an evaluation request for evaluating performance of a contact center agent. The evaluation request includes an identity of the contact center agent. For example, an evaluation request may be received from a human evaluator. However, it should be appreciated that, in some embodiments, the computing system may automatically perform evaluation of the corresponding contact center agent for every predetermined period without receiving an evaluation request from a human evaluator. In some embodiments, there may be more than one evaluation form for evaluating contact center agents. In such cases, the evaluation request may further specify the evaluation form to be used for evaluating the contact center agent. Alternatively, the computing system may determine the evaluation form to be used for evaluating the contact center agent based on the identity of the contact center agent (e.g., the experience level of the contact center agent, the nature of the assigned tasks to the contact center agent, and/or other contextual criteria) using the automated evaluator.

In block 504, the computing system obtains conversation data between the contact center agent and a customer. For example, the computing system is configured with a conversation recording policy that specifies criteria for filtering conversations for evaluation purposes. The criteria may include a date range (e.g., a date range), a queue, and/or a media type (e.g., call, chat, message, and/or email) of the conversation data. A random sample of a conversation may be selected from the filtered set of conversations using a randomized algorithm (e.g., reservoir sampling). However, it should be appreciated that, in some embodiments, the computing system may be configured to evaluate the overall performance of the contact center agent over a predetermined time period. In such cases, the computing system may analyze conversation data collected from multiple interactions that occurred during that predetermined time period.

The conversation data is structured as turn-by-turn utterances (e.g., voice or text) between contact center agents and customers via call, chat, message, and/or email. Exemplary conversation data includes transcripts, chat logs, message logs, and/or email threads of conversations between the contact center agent and the customer. Additionally, the conversation data may be retrieved using application programming interfaces (APIs) in the computing system. It should be appreciated that, in some embodiments, the conversation data may be retrieved using a generative AI to generate a query (e.g., structured query language (SQL) query) or an API call based on API documentation in the computing system.

In some embodiments, the computing system may fetch conversation data between the contact center agent and the customer. The human evaluator may select a data source of the conversation data. For example, the human evaluator may define a data range (e.g., a date range) and a media type (e.g., call, chat, message, and/or email) of the conversation data to be fetched from a data storage (e.g., a storage device 220 of the contact center system 200). The human evaluator may further request to fetch the conversation data from a specific queue. Alternatively, in other embodiments, the human evaluator may upload one or more files that contain conversation data to the computing system.

In block 506, the computing system obtains an evaluation form applicable to the contact center agent. As described above, if there are more than one evaluation form for evaluating contact center agents, the evaluation request may indicate the evaluation form to be used for evaluating the contact center agent. For example, more experienced contact center agents may be evaluated using a different evaluation form than less experienced contact center agents. In other words, the evaluation form may be selected based on the experience level of the contact enter agent. Alternatively, the computing system may use the automated evaluator to automatically determine the evaluation form to be used for evaluating the contact center agent based on the identity of the contact center agent (e.g., the experience level of the contact center agent, the nature of the assigned tasks to the contact center agent, and/or other contextual criteria). It should be appreciated that, in some embodiments, the evaluation form may further include possible answer options to the evaluation question and/or question clarifier text associated with the evaluation question.

In block 508, the computing system extracts an evaluation question from the evaluation form. For example, the evaluation question may be “Was the agent professional?” It should be appreciated that, in some embodiments, the evaluation form may include multiple evaluation questions. In such embodiments, the computing system is configured to repeat blocks 510-528 of the method 500 for each evaluation question from the evaluation form. It should be appreciated that, in some embodiments, the process (i.e., blocks 510-528) may be performed in parallel, such that all evaluation questions are evaluated simultaneously to generate suggested answers.

In block 510, the computing system determines a suggested answer to the evaluation question, a reasoning for the suggested answer, and a confidence score of the suggested answer using the automated evaluator. As described above, the evaluation form may include multiple answer options. In such cases, the suggested answer is selected from the multiple answer options. The reasoning provides an explanation for why the automated evaluator generated the suggested answer in response to the evaluation question. The confidence score indicates a level of confidence of the suggested answer generated by the automated evaluator. For example, as shown in FIG. 3B, if the evaluator question is “Was the agent professional?” and the answer options are “Yes” or “No,” the automated evaluator may select “No” as the suggested answer and provide the reasoning for the selection.

In block 512, the computing system determines if an automated scoring feature for the evaluation question is disabled. The status of the automated scoring feature indicates whether the suggested answer generated by the automated evaluator should be displayed on the evaluation form to a human evaluator via a user interface. For example, if the automated scoring feature for the evaluation question is enabled, the suggested answer generated by the automated evaluator will be displayed on the evaluation form and presented to a human evaluator on a user interface. However, if the automated scoring feature for the evaluation question is disabled, the automated evaluator will still generate a suggested answer for the evaluation question, but the suggested answer will neither be displayed on the evaluation form nor made visible to a human evaluator.

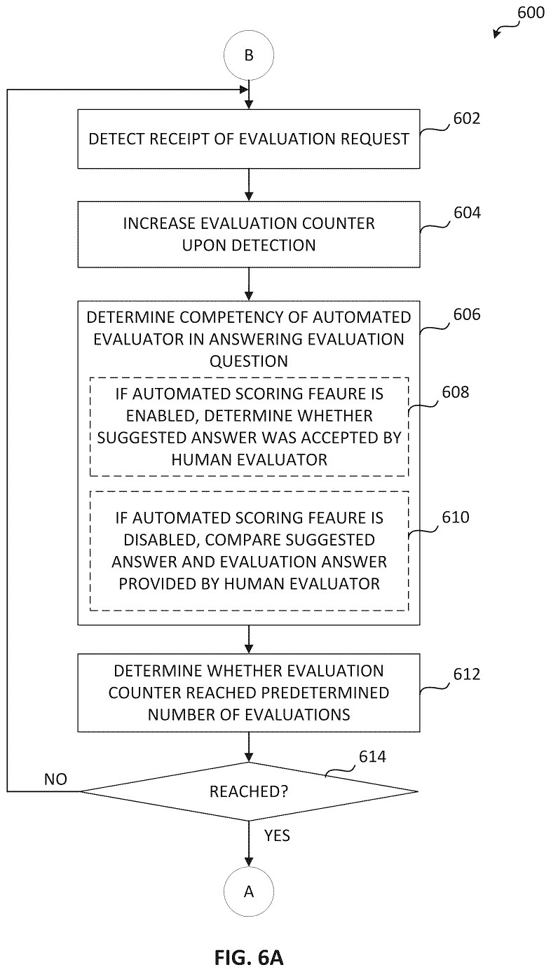

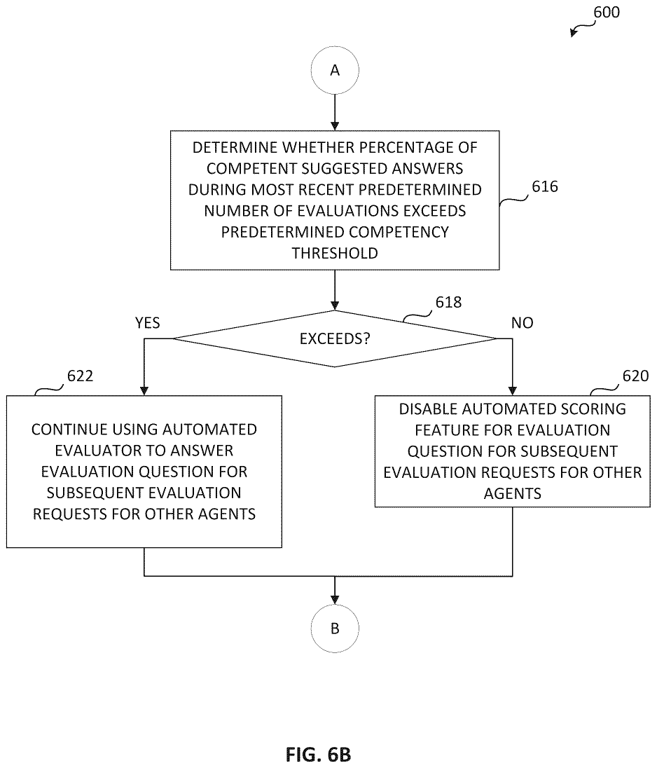

As described further below in FIGS. 6A and 6B, the performance of the automated evaluator is continuously or periodically assessed to ensure the competency of the suggested answers generated by the automated evaluator. If the computing system determines that the competency of the automated evaluator in generating a suggested answer for the particular evaluation question is below a predetermined competency threshold, the automated scoring feature will be disabled to prevent presentation of the suggested answer on the evaluation form. It should be appreciated that the competency of the automated evaluator may depend on various factors. For example, such factors may include the clarity or context of the evaluation question, the quality of the conversation data (e.g., an interaction transcript), and/or the language proficiency of the automated evaluator (e.g., a large language model (LLM)).

If the computing system determines that the automated scoring feature is disabled in block 514, the method 500 advances to block 516. In block 516, the computing system prevents presentation of the suggested answer to the evaluation question on the evaluation form and receives an input from a human evaluator. For example, the input may be an evaluation answer provided by a human evaluator for the evaluation question. Subsequently, the method 500 ends.

Referring back to block 512, if the computing system determines that the automated scoring feature is enabled, the method 500 advances to block 518 in FIG. 5B. In block 518, the computing system determines if the confidence score associated with the suggested answer exceeds a predetermined confidence threshold. The predetermined confidence threshold indicates a level of certainty or accuracy of the suggested answer (i.e., prediction) made by the automated evaluator. In other words, if the confidence score exceeds the predetermined confidence threshold, the suggested answer is deemed reliable and trustworthy.

If the computing system determines that the confidence score exceeds the predetermined confidence threshold in block 520, the method 500 advances to block 522 to display the suggested answer and the reasoning generated by the automated evaluator on the evaluation form to a human evaluator via a user interface (e.g., as illustrated in the screenshot 302 in FIG. 3B). Subsequently, the computing system receives an input from the human evaluator, as indicated in block 526. For example, the human evaluator may choose to accept the suggested answer. Alternatively, the human evaluator may choose to clear the suggested answer from the evaluation form and manually provide an evaluation answer to the evaluation questions.

Referring back to block 520, if the computing system determines that the confidence score does not exceed the predetermined confidence threshold, the method 500 advances to block 526. In block 526, the computing system prevents presentation of the suggested answer and the reasoning on the evaluation form. In other words, the computing system deems the suggested answer and the reasoning provided by the automated evaluator to be unreliable, and accordingly omits them from the evaluation form. Subsequently, in block 528, the computing system receives an evaluation answer from a human evaluator and updates the evaluation form to include the evaluation answer provided by the human evaluator.

Although the blocks 502-528 are described in a relatively serial manner, it should be appreciated that various blocks of the method 500 may be performed in parallel in some embodiments.

Referring now to FIGS. 6A and 6B, an exemplary assessment process or method 600 is shown in accordance with aspects of the present disclosure. More specifically, in use, a computing system (e.g., the computing device 100, the contact center system 200, and/or other computing devices described herein) may execute a method 600 for assessing the performance of an automated evaluator on a per-evaluation question basis. It should be appreciated that the particular blocks of the method 600 are illustrated by way of example, and such blocks may be combined or divided, added or removed, and/or reordered in whole or in part depending on the particular embodiment, unless stated to the contrary.

The method 600 begins with block 602 in which the computing system detects a receipt of an evaluation request for evaluating a performance of a contact center agent. As described above, the evaluation of each contact center agent is performed using an evaluation form that includes one or more evaluation questions designed to assess performance. It should be noted that the performance of the automated evaluator in generating suggested answers for a given evaluation question depends on various factors. For example, such factors may include the clarity or context of the evaluation question itself, the quality of the conversation data (e.g., an interaction transcript), and/or the language proficiency of the automated evaluator (e.g., a large language model (LLM)). In other words, the automated evaluator may perform differently depending on the evaluation question. As such, the performance of automated evaluator is assessed for each evaluation question on the evaluation form. It should be appreciated that, in some cases, different evaluation forms may be utilized depending on factors such as the agent's experience level, the nature of their assigned tasks, and other contextual criteria. However, for simplicity, it is assumed that each evaluation request received in block 602 involves evaluating a corresponding contact center agent using the same evaluation form.

Upon detecting the receipt of the evaluation request, the computing system increases an evaluation counter associated with the evaluation question, as illustrated in block 604. The evaluation counter indicates the number of evaluations performed by the automated evaluator. In other words, the evaluation counter tracks the number of times the automated evaluator has generated a suggested answer for the evaluation question on the evaluation form. This allows the computing system to assess the performance of the automated evaluator after a predetermined number of evaluations is reached, ensuring that sufficient data is collected to enable an accurate assessment.

In block 606, the computing system determines the competency of the automated evaluator in answering the evaluation question. To do so, the computing system determines whether an automated scoring feature is enabled for the evaluation question. As described above, the status of the automated scoring feature indicates whether a suggested answer generated by the automated evaluator should be displayed on the evaluation form to a human evaluator via a user interface. For example, if the automated scoring feature for the evaluation question is enabled, the suggested answer generated by the automated evaluator will be displayed on the evaluation form and presented to a human evaluator on a user interface. However, if the automated scoring feature for the evaluation question is disabled, the automated evaluator will still generate a suggested answer for the evaluation question in the backend, but the suggested answer will neither be displayed on the evaluation form nor made visible to a human evaluator.

If the automated scoring feature is enabled for the evaluation question, the computing system determines whether the suggested answer generated by the automated generator for the evaluation question was accepted by a human evaluator, as illustrated in block 608. As describe above, the suggested answer generated by the automated generator for the evaluation question is provided on the evaluation form to a human evaluator. The human evaluator then reviews the suggested answer and its reasoning for the suggested answer and decides whether to accept the suggested answer. Alternatively, the human evaluator may decide to reject the suggested answer by clearing the suggested answer and its reasoning from the evaluation form.

However, it should be appreciated that if the automated scoring feature is enabled for the evaluation question but the suggested answer has a confidence score lower than the predetermined confidence threshold (e.g., as described in block 522 in FIG. 5B), the suggested answer will not be presented to the human evaluator. In such an example, the computing system compares the suggested answer and the evaluation answer to determine the competency of the automated evaluator. If the suggested answer and the evaluation answer match, the suggested answer is deemed a competent suggested answer.

If the automated scoring feature is disabled for the evaluation question, the computing system compares the suggested answer generated by the automated evaluator in the backend and an evaluation answer provided by a human evaluator to determine the competency of the automated evaluator, as illustrated in block 610.

Subsequently, in block 612, the computing system determines whether the evaluation counter reached a predetermined number of evaluations. For example, the predetermined number of evaluations may be 100 evaluations of contact center agents using the evaluation form. This ensures that sufficient samples of suggested answers generated by the automated evaluator are collected to enable an accurate assessment of the performance of the automated evaluator.

If the computing system determines that the evaluation counter has not reached the predetermined number of evaluations in block 614, the method 600 loops back to block 602 to continue detecting a receipt of a subsequent evaluation request. If, however, the computing system determines that the evaluation counter has reached the predetermined number of evaluations in block 614, the method 600 advances to block 616 in FIG. 6B.

In block 616, the computing system determines whether the percentage of competent suggested answers during the most recent predetermined number of evaluations (e.g., last 100 evaluations) exceeds a predetermined competency threshold (e.g., 90%). The competent suggested answers refer to the suggested answers generated by the automated evaluator that were either accepted by the human evaluator or matched the evaluation answers provided by the human evaluator. It should be noted that the predetermined number of evaluations represents a sliding sample window that updates with each new evaluation.

If the percentage of the competent suggested answers does not exceed the predetermined competency threshold in block 618, the computing system determines that the automated evaluator is incompetent in answering the evaluation question on the evaluation form, and the method 600 advances to block 620. In block 620, the computing system disables the automated scoring feature for the evaluation question for subsequent evaluation requests for other contact center agents. It should be appreciated that when the automated scoring feature is disabled, the automated evaluator will still generate suggested answers for the evaluation question in the backend, but the generated answers will not be visible to a human evaluator (e.g., not displayed on a user interface). Subsequently, the method 600 will loop back to block 602 to continue evaluating the performance of the automated evaluator based on subsequent evaluations.

Referring back to block 618, if the percentage of the competent suggested answers exceeds the predetermined competency threshold, the computing system determines that the automated evaluator is competent in answering the evaluation question on the evaluation form, and the method 600 advances to block 622. In block 622, the computing system continues using the automated evaluator to answer the evaluation question for subsequent evaluation requests for other contact center agents. In the case where the automated scoring feature was previously disabled due to incompetency during the previous evaluation of the automated evaluator (e.g., block 620), the computing system re-enables the automated scoring feature.

Although the blocks 602-622 are described in a relatively serial manner, it should be appreciated that various blocks of the method 600 may be performed in parallel in some embodiments.

As one of skill in the art will appreciate, the many varying features and configurations described above in relation to the several exemplary embodiments may be further selectively applied to form the other possible embodiments of the present disclosure. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In accordance with at least one example of the present disclosure, a method of automated agent evaluation is provided. The method may include receiving an evaluation request for evaluating a performance of an agent, obtaining conversation data between the agent and a customer, obtaining an evaluation question from an evaluation form applicable to the agent, automatically generating a suggested answer to the evaluation question using an automated evaluator, and displaying the suggested answer on the evaluation form on a graphical user interface.

In accordance with at least one aspect of the above method, the method may further include determining whether an automated scoring feature is enabled for the evaluation question, in response to determining that the automated scoring feature is enabled for the evaluation question, displaying the suggested answer on the evaluation form on a graphical user interface, and in response to determining that the automated scoring feature is disabled for the evaluation question, preventing presentation of the suggested answer on the evaluation form to a human evaluator via the graphical user interface.

In accordance with at least one aspect of the above method, the method may further include automatically generating a reasoning for the suggested answer and a confidence score associated with the suggested answer using the automated evaluator, determining whether an automated scoring feature is enabled for the evaluation question, in response to determining that the automated scoring feature is enabled for the evaluation question, determining whether the confidence score exceeds a predetermined confidence threshold, and displaying the suggested answer on the evaluation form with the reasoning on the graphical user interface in response to determining that the automated scoring feature is enabled for the evaluation question and the confidence score exceeds the predetermined confidence threshold.

In accordance with at least one aspect of the above method, the method may further include in response to determining that the confidence score does not exceed the predetermined confidence threshold, preventing presentation of the suggested answer and the reasoning on the evaluation form.

In accordance with at least one aspect of the above method, the method may further include determining competency of the automated evaluator in answering the evaluation question, and determining whether a percentage of competent suggested answers during the most precent predetermined number of evaluations exceeds a predetermined competency threshold.

In accordance with at least one aspect of the above method, the method may include where the competent suggested answers are one or more suggested answers generated by the automated evaluator for the evaluation question that were either accepted by a human evaluator or matched evaluation answers provided by a human evaluator.

In accordance with at least one aspect of the above method, the method may include where determining competency of the automated evaluator in answering the evaluation question comprises determining if an automated scoring feature for the evaluation question is enabled, in response to determining that the automated scoring feature is enabled, determining whether the suggested answer was accepted by a human evaluator, and in response to determining that the automated scoring feature is disabled, comparing whether the suggested answer and an evaluation answer provided by a human evaluator.

In accordance with at least one aspect of the above method, the method may further include in response to determining that the percentage of competent suggested answers during the most precent predetermined number of evaluations exceeds the predetermined competency threshold, continue using the automated evaluator to answer the evaluation question for subsequent evaluation requests or re-enabling an automated scoring feature for the evaluation question if the automated scoring feature for the evaluation question was previously disabled.

In accordance with at least one aspect of the above method, the method may further include in response to determining that the percentage of competent suggested answers during the most precent predetermined number of evaluations does not exceed the predetermined competency threshold, disabling an automated scoring feature for the evaluation question for subsequent evaluation requests.

In accordance with at least one aspect of the above method, the method may include where the competency of the automated evaluator in answering the evaluation question depends on a clarity or context of the evaluation question, a quality of the conversation data, and/or a language proficiency of the automated evaluator.

In accordance with at least one aspect of the above method, the method may include where obtaining the evaluation question from the evaluation form applicable to the agent further comprising obtaining the evaluation question, possible answers to the evaluation question, and/or question clarifier text associated with the evaluation question from the evaluation form.

In accordance with at least one example of the present disclosure, a computing system for automated agent evaluation is provided. The computing system may include at least one processor and at least one memory comprising a plurality of instructions stored therein that, in response to execution by the at least one processor, causes the computing system to receive an evaluation request for evaluating a performance of an agent, obtain conversation data between the agent and a customer, obtain an evaluation question from an evaluation form applicable to the agent, automatically generate a suggested answer to the evaluation question using an automated evaluator, and display the suggested answer on the evaluation form on a graphical user interface.

In accordance with at least one aspect of the above computing system, the computing system may include the plurality of instructions, in response to execution by the at least one processor, further causes the computing system to determine whether an automated scoring feature is enabled for the evaluation question, in response to determination that the automated scoring feature is enabled for the evaluation question, display the suggested answer on the evaluation form on a graphical user interface, and in response to determination that the automated scoring feature is disabled for the evaluation question, prevent presentation of the suggested answer on the evaluation form to a human evaluator via the graphical user interface.

In accordance with at least one aspect of the above computing system, the computing system may include the plurality of instructions, in response to execution by the at least one processor, further causes the computing system to automatically generate a reasoning for the suggested answer and a confidence score associated with the suggested answer using the automated evaluator, determine whether an automated scoring feature is enabled for the evaluation question, in response to determination that the automated scoring feature is enabled for the evaluation question, determine whether the confidence score exceeds a predetermined confidence threshold, and display the suggested answer on the evaluation form with the reasoning on the graphical user interface in response to determination that the automated scoring feature is enabled for the evaluation question and the confidence score exceeds the predetermined confidence threshold.

In accordance with at least one aspect of the above computing system, the computing system may include the plurality of instructions, in response to execution by the at least one processor, further causes the computing system to in response to determination that the confidence score does not exceed the predetermined confidence threshold, prevent presentation of the suggested answer and the reasoning on the evaluation form.

In accordance with at least one aspect of the above computing system, the computing system may include the plurality of instructions, in response to execution by the at least one processor, further causes the computing system to determine competency of the automated evaluator in answering the evaluation question, and determine whether a percentage of competent suggested answers during the most precent predetermined number of evaluations exceeds a predetermined competency threshold.

In accordance with at least one aspect of the above computing system, the computing system may include the plurality of instructions, in response to execution by the at least one processor, further causes the computing system to in response to determination that the percentage of competent suggested answers during the most precent predetermined number of evaluations exceeds the predetermined competency threshold, continue using the automated evaluator to answer the evaluation question for subsequent evaluation requests or re-enable an automated scoring feature for the evaluation question if the automated scoring feature for the evaluation question was previously disabled.

In accordance with at least one aspect of the above computing system, the computing system may include the plurality of instructions, in response to execution by the at least one processor, further causes the computing system to in response to determination that the percentage of competent suggested answers during the most precent predetermined number of evaluations does not exceed the predetermined competency threshold, disable an automated scoring feature for the evaluation question for subsequent evaluation requests.

In accordance with at least one aspect of the above computing system, the computing system may include where the competency of the automated evaluator in answering the evaluation question depends on a clarity or context of the evaluation question, a quality of the conversation data, and/or a language proficiency of the automated evaluator.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

That which is claimed:

1. A method of automated agent evaluation, the method comprising:
receiving an evaluation request for evaluating a performance of an agent;
obtaining conversation data between the agent and a customer;
obtaining an evaluation question from an evaluation form applicable to the agent; and
automatically generating a suggested answer to the evaluation question using an automated evaluator.

2. The method of claim 1, further comprising:
determining whether an automated scoring feature is enabled for the evaluation question;
in response to determining that the automated scoring feature is enabled for the evaluation question, displaying the suggested answer on the evaluation form on a graphical user interface; and
in response to determining that the automated scoring feature is disabled for the evaluation question, preventing presentation of the suggested answer on the evaluation form to a human evaluator via the graphical user interface.

3. The method of claim 1, further comprising:
automatically generating a reasoning for the suggested answer and a confidence score associated with the suggested answer using the automated evaluator;
determining whether an automated scoring feature is enabled for the evaluation question;
in response to determining that the automated scoring feature is enabled for the evaluation question, determining whether the confidence score exceeds a predetermined confidence threshold; and
displaying the suggested answer on the evaluation form with the reasoning on the graphical user interface in response to determining that the automated scoring feature is enabled for the evaluation question and the confidence score exceeds the predetermined confidence threshold.

4. The method of claim 3, further comprising:
in response to determining that the confidence score does not exceed the predetermined confidence threshold, preventing presentation of the suggested answer and the reasoning on the evaluation form.

5. The method of claim 1, further comprising:
determining competency of the automated evaluator in answering the evaluation question; and
determining whether a percentage of competent suggested answers during the most precent predetermined number of evaluations exceeds a predetermined competency threshold.

6. The method of claim 5, wherein the competent suggested answers are one or more suggested answers generated by the automated evaluator for the evaluation question that were either accepted by a human evaluator or matched evaluation answers provided by a human evaluator.

7. The method of claim 5, wherein determining competency of the automated evaluator in answering the evaluation question comprises:
determining if an automated scoring feature for the evaluation question is enabled;
in response to determining that the automated scoring feature is enabled, determining whether the suggested answer was accepted by a human evaluator; and
in response to determining that the automated scoring feature is disabled, comparing whether the suggested answer and an evaluation answer provided by a human evaluator.

8. The method of claim 5, further comprising:
in response to determining that the percentage of competent suggested answers during the most precent predetermined number of evaluations exceeds the predetermined competency threshold, continue using the automated evaluator to answer the evaluation question for subsequent evaluation requests or re-enabling an automated scoring feature for the evaluation question if the automated scoring feature for the evaluation question was previously disabled.

9. The method of claim 5, further comprising:
in response to determining that the percentage of competent suggested answers during the most precent predetermined number of evaluations does not exceed the predetermined competency threshold, disabling an automated scoring feature for the evaluation question for subsequent evaluation requests.

10. The method of claim 5, wherein the competency of the automated evaluator in answering the evaluation question depends on a clarity or context of the evaluation question, a quality of the conversation data, and/or a language proficiency of the automated evaluator.

11. The method of claim 1, wherein obtaining the evaluation question from the evaluation form applicable to the agent further comprising obtaining the evaluation question, possible answers to the evaluation question, and/or question clarifier text associated with the evaluation question from the evaluation form.

12. A computing system for automated agent evaluation, the system comprising:
at least one processor; and
at least one memory comprising a plurality of instructions stored therein that, in response to execution by the at least one processor, causes the computing system to:
receive an evaluation request for evaluating a performance of an agent;
obtain conversation data between the agent and a customer;
obtain an evaluation question from an evaluation form applicable to the agent; and
automatically generate a suggested answer to the evaluation question using an automated evaluator.

13. The computing system of claim 12, wherein the plurality of instructions, in response to execution by the at least one processor, further causes the computing system to:
determine whether an automated scoring feature is enabled for the evaluation question;
in response to determination that the automated scoring feature is enabled for the evaluation question, display the suggested answer on the evaluation form on a graphical user interface; and
in response to determination that the automated scoring feature is disabled for the evaluation question, prevent presentation of the suggested answer on the evaluation form to a human evaluator via the graphical user interface.

14. The computing system of claim 12, wherein the plurality of instructions, in response to execution by the at least one processor, further causes the computing system to:
automatically generate a reasoning for the suggested answer and a confidence score associated with the suggested answer using the automated evaluator;
determine whether an automated scoring feature is enabled for the evaluation question;
in response to determination that the automated scoring feature is enabled for the evaluation question, determine whether the confidence score exceeds a predetermined confidence threshold; and
display the suggested answer on the evaluation form with the reasoning on the graphical user interface in response to determination that the automated scoring feature is enabled for the evaluation question and the confidence score exceeds the predetermined confidence threshold.

15. The computing system of claim 14, wherein the plurality of instructions, in response to execution by the at least one processor, further causes the computing system to:
in response to determination that the confidence score does not exceed the predetermined confidence threshold, prevent presentation of the suggested answer and the reasoning on the evaluation form.

16. The computing system of claim 12, wherein the plurality of instructions, in response to execution by the at least one processor, further causes the computing system to:
determine competency of the automated evaluator in answering the evaluation question; and
determine whether a percentage of competent suggested answers during the most precent predetermined number of evaluations exceeds a predetermined competency threshold.

17. The computing system of claim 16, wherein to determine the competency of the automated evaluator in answering the evaluation question comprises to:
determine if an automated scoring feature for the evaluation question is enabled;
in response to determination that the automated scoring feature is enabled, determine whether the suggested answer was accepted by a human evaluator; and
in response to determination that the automated scoring feature is disabled, compare whether the suggested answer and an evaluation answer provided by a human evaluator.

18. The computing system of claim 16, wherein the plurality of instructions, in response to execution by the at least one processor, further causes the computing system to:
in response to determination that the percentage of competent suggested answers during the most precent predetermined number of evaluations exceeds the predetermined competency threshold, continue using the automated evaluator to answer the evaluation question for subsequent evaluation requests or re-enable an automated scoring feature for the evaluation question if the automated scoring feature for the evaluation question was previously disabled.

19. The computing system of claim 16, wherein the plurality of instructions, in response to execution by the at least one processor, further causes the computing system to:
in response to determination that the percentage of competent suggested answers during the most precent predetermined number of evaluations does not exceed the predetermined competency threshold, disable an automated scoring feature for the evaluation question for subsequent evaluation requests.

20. The computing system of claim 16, wherein the competency of the automated evaluator in answering the evaluation question depends on a clarity or context of the evaluation question, a quality of the conversation data, and/or a language proficiency of the automated evaluator.
